(19) United States
(12) Patent Application Publication
(10) Pub. No.: US 2007/0105733 A1
(43) Pub. Date: May 10, 2007

(54) METHOD FOR TREATING TEXTILES AND ARTICLES OF CLOTHING

(75) Inventor: Veronica BOLARI, Luzzana (Bergamo) (IT)

Correspondence Address: HESLIN ROTHENBERG FARLEY & MESITI PC, 5 COLUMBIA CIRCLE, ALBANY, NY, 12203, US

(73) Assignee: SAGITTA SRL., Luzzana (Bergamo) (IT)

(21) Appl. No.: 11/553,726

(22) Filed: Oct. 27, 2006

(30) Foreign Application Priority Data
Nov. 9, 2005 (IT) TO2005A000788

(51) Int. Cl. C11D 3/50; C11D 9/44

(52) U.S. Cl. 510/101

(57) ABSTRACT

A method to treat a textile and/or article of clothing including the application of aloe vera to the textile/article of clothing, preferably in a water bath.

### CROSS-REFERENCE TO RELATED APPLICATIONS

This application claims priority to Italian Patent Application No. TO2005A000788, filed Nov. 9, 2005, the disclosure of which is incorporated by reference in its entirety.

This application contains subject matter which is related to the subject matter of co-owned U.S. patent application Ser. No. 11/553,553, filed Oct. 27, 2006, by Veronica Bolari, entitled “SOFTENING COMPOSITION” (Attorney Docket No. 2177.077 (BUS8317-CF/sr), which is assigned to the same assignee as this application, and which is hereby incorporated herein by reference in its entirety.

### BACKGROUND OF THE INVENTION

The present invention concerns a method for treating textiles in the bolt and made-up articles of clothing.

The method object of the present invention lies within the sphere of finishing procedures for a textile or for a made-up article of clothing, where by the term finishing is meant the operations of dressing the textile or garment to be performed as the last phase of a washing or dyeing process.

Finishing procedures include the operations of dressing textiles or articles of clothing, among which may be mentioned as examples teasing, cropping, calandering, steaming and delustering. The purpose of finishing procedures is to give the textile or article of clothing characteristics that improve their appearance, presentation and drape, and make them more suitable for the purposes for which they are destined. Again part of the phase of finishing procedures are treatments of high-grade nobilitation capable of improving the characteristics of use and upkeep of the textiles and of garments made with chemical fibres in general and cellulose fibres in particular.

Procedures that tend to give textiles a particular feel or hand and, in consequence, that add greater comfort for the end-user who wears the garment, thus belong to this latter category of treatments.

Treatments of this type have been described in numerous patent and other documents. As an example, documents EP-A-0 436 729 and EP-A-1 152 080 may be cited; these documents describe procedures and compositions to apply to textiles to improve the physiological condition of the skin or simply the ease and comfort of wearing articles of clothing made up from these textiles. In particular, patent document EP-A-1 152 080 provides for the application to textiles of a functional film, resistant to water, containing micro-capsules based on polymers or rubbers and aloe vera. Such micro-capsules release their content of aloe vera as a result of the mechanical destruction of their outer wall.

The use of micro-capsules containing aloe vera nevertheless presents some drawbacks; the first is that of releasing a very large quantity of aloe vera onto the skin of whoever wears the article of clothing, the second is that, instead of the fabric, for example, cotton or linen, being next to the skin, there is a film resistant to water, and thus substantially impermeable and not appropriate for the correct transpiration of the skin such as to enable whoever wears the fabric or garment to transpire.

Object of the invention is providing a finishing or high-grade nobilitation procedure that does not present the drawbacks of the known technology.

### SUMMARY OF THE INVENTION

According to the present invention, this object is achieved thanks to the solution described in detail in the attached claims. The claims form an integral part of the technical instruction provided here in regard to the invention.

In an embodiment at present preferred the invention concerns a procedure for treating a textile or an article of clothing to be performed at the end of the washing or dyeing process, where such treatment provides for the application of a water bath containing aloe vera.

Application of aloe vera, and thus its penetration into the fibres of the textile or article of clothing, gives to the treated product a particular hand, softness and slipperiness that improves its characteristics of use. More specifically, once it is worn the fabric releases a part of the absorbed aloe with a consequent sensation of well-being on the skin of whoever wears the garment, such as, for example, a sensation of a smooth and velvety skin.

### DETAILED DESCRIPTION OF THE INVENTION

The invention will now be described in detail, as a simple example without limiting intent.

The finishing treatment with aloe vera is a procedure that is preferably performed as the last phase of the washing or dyeing process.

More specifically, the aloe vera is applied in a water bath with a “bath ratio”, understood as the ratio between the quantity of liquid used in the treatment and the quantity of textile treated, of 1:10. The application of this water bath may for example take place in a washing machine.

The aloe vera preferably used in the sphere of the present invention comprises a water-based silicon emulsion with Aloe Vera, in which the siloxane component presents aminoalkyl groups and is indexed in Chemical Abstracts under reference number CAS N. 75718-16-0 15-25% Xi R36. Nevertheless, it should be understood that in the sphere of the present invention aloe vera may be used in any other form or in combination with any other chemical compound.

The quantity of aloe vera contained in the water bath is related to the weight/quantity of textile/garments to be treated and varies in the range between 4 and 10% by weight.

The treatment lasts for approximately 6-10 minutes and is performed hot, preferably at a temperature of 30-40° C.

The textile or the articles of clothing are then centrifuged and dried.

In a particularly preferred embodiment, the textile or articles of clothing are subsequently sprayed with a perfume aerosol; specifically, the composition of perfume contains amber and lavender as fragrances and water. Application of the perfume aerosol comes about in a tumbler (machine that imparts a circular movement fitted with a window through which the garments may be sprayed) for approximately 30 seconds, which is followed by a period of five minutes to equalise the perfume.

From tests carried out by the applicant it is clear that the effect of treatment with aloe vera is resistant to approximately three household washes at a temperature of about 40° C.

Naturally, details of performance and embodiments may be widely varied with regard to what is described and illustrated without thereby departing from the sphere of protection of the present invention, as defined by the attached claims.

1. Method to treat a textile and/or an article of clothing, comprising applying aloe vera to at least one of a textile and an article of clothing.

2. Method according to claim 1, wherein the aloe vera is applied by means of a water bath.

3. Method according to claim 1, wherein the aloe vera is present in a quantity between 4 and 10% by weight with regard to the weight of the at least one of a textile and an article of clothing to be treated.

4. Method according to claim 2, wherein the water bath presents a bath ratio of 1:10.

5. Method according to claim 1, wherein the applying is performed on completion of washing or dyeing procedures.

6. Method according to claim 1, wherein the applying the aloe vera is performed under warm conditions.

7. Method according to claim 6, wherein the applying is performed at a temperature of 30-40° C.

8. Method according to claim 1, wherein the applying has a duration of less than about 20 minutes.

9. Method according to claim 1, further comprising drying the at least one of a textile and an article of clothing.

10. Method according to claim 1, further comprising applying a perfume aerosol to the at least one of a textile and an article of clothing.

11. Method according to claim 10, wherein the perfume contains amber and lavender and water.

12. Method according to claim 10, wherein the applying the perfume takes place in a tumbler.

13. Method according to claim 1, wherein the applying has a duration of less than about 15 minutes.

14. Method according to claim 1, wherein the applying has a duration of less than about 6-10 minutes.
